(19) United States
(12) Patent Application Publication
(10) Pub. No.: US 2011/0196096 A1
(43) Pub. Date: Aug. 11, 2011

(54) METHOD FOR PRODUCING SILICONE MOULDED BODIES FROM LIGHT-CURABLE SILICONE MIXTURES

(75) Inventors: Klaus Angermaier, Muenchen (DE); Philipp Mueller, Burghausen (DE)

(73) Assignee: WACKER CHEMIE AG, Muenchen (DE)

(21) Appl. No.: 13/119,360

(22) PCT Filed: Oct. 26, 2009
(86) PCT No.: PCT/EP09/64079

§ 371 Date: Mar. 16, 2011

(30) Foreign Application Priority Data
Oct. 30, 2008 (DE) 10 2008 043 316.0

(51) Int. Cl. C08L 83/04; B29C 35/08; B29D 11/00

(52) U.S. Cl. 525/100; 264/494; 264/1.38

(57) ABSTRACT

The invention relates to a method for producing silicone moulded BODIES wherein 1) a light-curable silicone mixture is moulded, 2) the moulded silicone mixture is then irradiated with light of 200 to 500 nm in order to cure the same such as to maintain the shape thereof at a temperature T and 3) then to thermally cure the moulded and irradiated silicone mixture at the temperature T to give moulded bodies.

The invention relates to a process for producing silicone moldings made from silicone mixtures that can be crosslinked by light, where light is used to precrosslink the molded silicone mixtures.

In glob-top applications, individual modules in electronic devices are protected by coating. Because of the design or the arrangement of the groups of components on the circuit board, the area wetted by the silicone after the application process is not permitted to expand during subsequent processing. This expansion would disrupt the functioning of the components in the vicinity.

Moldings made of silicone are in many cases produced by injection-molding processes. In the case of circuit-board coating, this would be impossible because it is not possible to produce a metal mold into which a circuit board could be inserted.

WO 2006/010763 A1 describes the use of light-activatable silicone mixtures for use in injection-molding processes and for thick-walled coatings. The light-activatable silicone mixture is irradiated, and then transferred to a shaping process, and then hardened without further irradiation.

Although moisture-crosslinking silicone compositions are self-supporting, there are many electronics applications in which they cannot be used, since they require undesirable atmospheric moisture for the crosslinking process and they liberate volatile compounds, e.g. alcohols, acetic acid, and oximes. The severe shrinkage is unacceptable for moldings.

The invention provides a process for producing silicone moldings by

1) molding a silicone mixture that can be crosslinked by light,

2) then irradiating the molded silicone mixture with light at from 200 to 500 nm in order to precrosslink the mixture, in such a way that it retains its shape at a temperature T, and

3) then hardening the molded and irradiated silicone mixture thermally at the temperature T to give moldings.

The moldings made of silicone can be produced without the use of injection-molding processes, which are significantly more expensive. Handling costs and plant costs are reduced, and there are no downstream mechanical operations. The process can be used not only with short manufacturing runs but also with long runs. Thick coatings can be produced without the sort of metal mold typically used for injection-molding processes.

The light-induced precuring process permits retention of the exterior geometry of the silicone part even when it is heated, and this contrasts with the situation for conventional RTV silicones which can be used in processes involving dispensing technology. It is possible to produce moldings without using any exterior mold prescribing the geometric shape.

Because a silicone mixture that hardens or is activatable on exposure to light is used, the shape that the silicone mixture assumes after the molding process, inclusive of application process, for example dispensing process, injection process, or doctoring process, is retained via irradiation with light. The irradiation process partially crosslinks the silicone mixture and thus forms a network of sufficient stability.

The final hardening process with complete development of all of the properties of the material, e.g. hardness, strength, adhesion, is achieved in a subsequent thermal curing step.

Omission of the thermal postcuring process and hardening solely through exposure to light would not be possible, since certain properties within the profile of the material, e.g. adhesion properties, would not be developed.

With conventional addition-crosslinkable silicone compositions which are not hardened by light, the exterior shape of the molded silicone would be disrupted as temperature rises because of the change of viscosity; it is only the use of silicone mixtures that can be crosslinked by light that renders this process possible, since the initial light-initiated precuring process retains the original exterior geometry even when the material is heated.

The molding process preferably takes place at at least 0° C., particularly preferably at at least 10° C., in particular at at least 15° C., and preferably at at most 50° C., particularly preferably at at most 35° C., in particular at at most 25° C.

The duration of the irradiation of the molded silicone mixture with light is preferably at least 1 second, particularly preferably at least 5 seconds, and preferably at most 500 seconds, particularly preferably at most 100 seconds.

The onset of the hydrosilylation reaction causes the crosslinking of the silicone mixture to begin—the mixture gels.

After the process of irradiation with light, the molded and irradiated silicone mixture is preferably heated after at most 1 hour, particularly preferably after at most 10 minutes, in particular after at most 1 minute, in order to harden it to give moldings.

The temperature T is preferably at least 80° C., particularly preferably at least 100° C., in particular at least 120° C., and preferably at most 250° C., particularly preferably at most 200° C., in particular at most 160° C.

The duration of the hardening process at the temperature T is preferably at least 30 seconds, particularly preferably at least 1 minute, and preferably at most 10 minutes, particularly preferably at most 60 minutes.

The molding cures completely here and develops its complete property profile. The geometric shape of the molded silicone mixture does not change during the entire heating process.

The viscosity [D=0.5/25° C.] of the silicone mixture is preferably at least 10 000 mPas, in particular at least 20 000 mPas, preferably at most 2 000 000 mPas, in particular at most 100 000 mPas.

The silicone mixture that can be crosslinked by light at from 200 to 500 nm can be a mixture composed of 2 components or of only 1 component. The silicone mixture preferably comprises:
(A) polyorganosiloxane which has a viscosity at 25° C. of from 0.1 to 500 000 Pa·s and which comprises at least two alkenyl groups per molecule,
(B) organosilicon compound comprising at least two SiH functions per molecule, and
(C) platinum-group catalyst activatable by light at from 200 to 500 nm.

The constitution of the polyorganosiloxane (A) comprising alkenyl groups preferably corresponds to the average general formula (1)

R¹ₓR²_{y}SiO_{(4-x-y)/2} (1)

in which
R¹ is a monovalent, optionally halogen- or cyano-substituted C₁-C₁₀-hydrocarbon moiety which comprises aliphatic carbon-carbon multiple bonds and which optionally has bonding to silicon by way of an organic bivalent group,
R² is a monovalent, optionally halogen- or cyano-substituted C₁-C₁₀-hydrocarbon moiety which has bonding by way of SiC and which is free from aliphatic carbon-carbon multiple bonds,
x is a non-negative number such that at least two moieties R¹ are present in every molecule, and
y is a non-negative number such that (x+y) is in the range from 1.8 to 2.5.

The alkenyl groups R¹ are susceptible to an addition reaction with an SiH-functional crosslinking agent. It is usual to use alkenyl groups having from 2 to 6 carbon atoms, e.g. vinyl, allyl, methallyl, 1-propenyl, 5-hexenyl, ethynyl, butadienyl, hexadienyl, cyclopentenyl, cyclopentadienyl, cyclohexenyl, preferably vinyl and allyl.

Organic divalent groups by way of which the alkenyl groups R¹ can have bonding to silicon in the polymer chain are composed by way of example of oxyalkylene units such as those of the general formula (2)

—(O)ₘ[(CH₂)ₙO]ₒ— (2)

in which
m is the value 0 or 1, in particular 0,
n is a value from 1 to 4, in particular 1 or 2, and
o is a value from 1 to 20, in particular from 1 to 5.

The oxyalkylene units of the general formula (10) have bonding to a silicon atom on the left-hand side.

The bonding of the moieties R¹ can be at any position in the polymer chain, in particular to the terminal silicon atoms.

Examples of unsubstituted moieties R² are alkyl moieties, such as the methyl, ethyl, n-propyl, isopropyl, n-butyl, isobutyl, tert-butyl, n-pentyl, isopentyl, neopentyl, tert-pentyl moiety, hexyl moieties, such as the n-hexyl moiety, heptyl moieties, such as the n-heptyl moiety, octyl moieties, such as the n-octyl moiety, and isooctyl moieties, such as the 2,2,4-trimethylpentyl moiety, nonyl moieties, such as the n-nonyl moiety, decyl moieties, such as the n-decyl moiety; alkenyl moieties, such as the vinyl, allyl, n-5-hexenyl, 4-vinylcyclohexyl, and the 3-norbornenyl moiety; cycloalkyl moieties, such as cyclopentyl, cyclohexyl, 4-ethylcyclohexyl, cycloheptyl moieties, norbornyl moieties, and methylcyclohexyl moieties; aryl moieties, such as the phenyl, biphenylyl, naphthyl moiety; alkaryl moieties, such as o-, m-, p-tolyl moieties, and ethylphenyl moieties; aralkyl moieties, such as the benzyl moiety, and the alpha- and the β-phenylethyl moiety.

Examples of substituted hydrocarbon moieties as moieties R² are halogenated hydrocarbons, examples being the chloromethyl, 3-chloropropyl, 3-bromopropyl, 3,3,3-trifluoropropyl, and 5,5,5,4,4,3,3-hexafluoropentyl moiety, and also the chlorophenyl, dichlorophenyl, and trifluorotolyl moiety.

R² preferably has from 1 to 6 carbon atoms. Methyl and phenyl are particularly preferred.

Constituent (A) can also be a mixture of various polyorganosiloxanes comprising alkenyl groups, where these differ by way of example in the alkenyl group content, in the nature of the alkenyl group, or structurally.

The structure of the polyorganosiloxanes (A) comprising alkenyl groups can be linear, cyclic, or else branched. The content of tri- and/or tetrafunctional units leading to branched polyorganosiloxanes is typically very small, preferably at most 20 mol %, in particular at most 0.1 mol %.

Particular preference is given to the use of polydimethylsiloxanes which comprise vinyl groups and the molecules of which correspond to the general formula (3)

(ViMe₂SiO_{1/2})₂(ViMeSiO)ₚ(Me₂SiO)_{q} (3)

where the non-negative integers p and q comply with the following conditions: p≧0, 50<(p+q)<20 000, preferably 200<(p+q)<1000, and 0<(p+1)/(p+q)<0.2.

The viscosity of the polyorganosiloxane (A) at 25° C. is preferably from 0.5 to 100 000 Pa·s, in particular from 1 to 2000 Pa·s.

The constitution of the organosilicon compound (B) comprising at least two SiH functions per molecule is preferably that of the average general formula (4)

HₐR³_{b}SiO_{(4-a-b)/2} (4)

in which
R³ is a monovalent, optionally halogen- or cyano-substituted C₁-C₁₈-hydrocarbon moiety which has bonding by way of SiC and which is free from aliphatic carbon-carbon multiple bonds, and
a and b are non-negative integers, with the proviso that 0.5<(a+b)<3.0 and 0<a<2 and that at least two silicon-bonded hydrogen atoms are present per molecule.

Examples of R³ are the moieties stated for R². R³ preferably has from 1 to 6 carbon atoms. Methyl and phenyl are particularly preferred.

It is preferable to use an organosilicon compound (B) comprising three or more SiH bonds per molecule. If an organosilicon compound (B) is used that has only two SiH bonds per molecule, it is advisable to use a polyorganosiloxane (A) which has at least three alkenyl groups per molecule.

The hydrogen content of the organosilicon compound (B), where this relates exclusively to the hydrogen atoms directly bonded to silicon atoms, is preferably in the range from 0.002 to 1.7% by weight of hydrogen, preferably from 0.1 to 1.7% by weight of hydrogen.

The organosilicon compound (B) preferably comprises at least three and at most 600 silicon atoms per molecule. It is preferable to use organosilicon compound (B) which comprises from 4 to 200 silicon atoms per molecule.

The structure of the organosilicon compound (B) can be linear, branched, cyclic, or of network type.

Particularly preferred organosilicon compounds (B) are linear polyorganosiloxanes of the general formula (5)

(HR⁴₂SiO_{1/2})_{c}(R⁴₃SiO_{1/2})_{d}(HR⁴SiO_{2/2})ₑ(R⁴₂SiO_{2/2})_{f} (5)

where
the definition of R⁴ is as for R³, and
the non-negative integers c, d, e, and f comply with the following conditions: (c+d)=2, (c+e)>2, 5<(e+f)<200, and 1<e/(e+f)<0.1.

The amount of the SiH functional organosilicon compound (B) present in the crosslinkable silicone composition is preferably such that the molar ratio of SiH groups to alkenyl groups is from 0.5 to 5, in particular from 1.0 to 3.0.

The catalyst (C) used can comprise any of the known catalysts of the platinum group, where these catalyze the hydrosilylation reactions that proceed during the crosslinking of addition-crosslinking silicone compositions and can be activated by light at from 200 to 500 nm.

The catalyst (C) comprises at least one metal or one compound from platinum, rhodium, palladium, ruthenium, and iridium, preferably platinum.

Particularly suitable catalysts (C) are cyclopentadienyl complexes of platinum, preferably of the general formula (6)

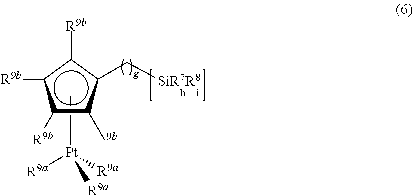

where
g=from 1 to 8,
H=from 0 to 2,
i=from 1 to 3,
R⁷, mutually independently, being identical or different, are a monovalent, unsubstituted or substituted, linear, cyclic, or branched hydrocarbon moiety which comprises aliphatically saturated or unsaturated or aromatically unsaturated moieties and which has from 1 to 30 carbon atoms, and in which individual carbon atoms can have been replaced by atoms of O, of N, of S, or of P,
R⁸, mutually independently, being identical or different, are hydrolyzable functional groups selected from the group consisting of
   carboxy —O—C(O)R¹⁰,
   oxime —O—N═CR¹⁰₂,
   alkoxy —OR¹⁰,
   alkenyloxy —O—R¹²
   amide —NR¹⁰—C(O)R¹¹,
   amine —NR¹⁰R¹¹,
   aminoxy —O—NR¹⁰R¹¹, where
   R¹⁰, mutually independently, being identical or different, are H, alkyl, aryl, arylalkyl, alkylaryl,
   R¹¹, mutually independently, being identical or different, are alkyl, aryl, arylalkyl, alkylaryl,
   R¹² is a linear or branched, aliphatically unsaturated organic moiety,
R^{9a}, mutually independently, being identical or different, are alkyl, aryl, arylalkyl, alkylaryl having from 1 to 30 carbon atoms, where the hydrogens can have been replaced by -Hal or —SiR₃⁹, where
   R⁹, mutually independently, being identical or different, are a monovalent, unsubstituted or substituted, linear, cyclic, or branched hydrocarbon moiety,
R^{9b}, mutually independently, being identical or different, are hydrogen or a monovalent, unsubstituted or substituted, linear or branched hydrocarbon moiety which comprises aliphatically saturated or unsaturated or aromatically unsaturated moieties and which has from 1 to 30 carbon atoms, and in which individual carbon atoms can have been replaced by atoms of O, of N, of S, or of P, and which can form annelated rings with the cyclopentadienyl moiety.

Preferred moieties R⁷ are linear saturated hydrocarbon moieties having from 1 to 8 carbon atoms. Preference is further given to the phenyl moiety.

Preferred moieties R⁸ are methoxy, ethoxy, acetoxy, and 2-methoxyethoxy groups.

Preferred moieties R^{9a} are linear and branched, optionally substituted alkyl moieties, such as methyl, ethyl, propyl, or butyl moieties.

Preferred moieties R^{9b} are linear and branched, optionally substituted linear alkyl moieties, such as methyl, ethyl, propyl, or butyl moieties. Preference is further given to optionally further substituted annelated rings, an example being the indenyl moiety or the fluorenyl moiety.

MeCp(PtMe₃) is particularly preferred as catalyst (C).

Catalyst (C) can be used in any desired form, including by way of example that of microcapsules comprising hydrosilylation catalyst, or that of organopolysiloxane particles, as described in EP-A-1006147.

The content of hydrosilylation catalysts (C) is preferably selected in such a way that the content of metal of the platinum group in the silicone mixture is from 0.1 to 200 ppm, preferably from 0.5 to 40 ppm.

The silicone mixture is preferably transparent and free from light-absorbing fillers.

However, the silicone mixture can also comprise filler (D). Examples of non-reinforcing fillers (D) are fillers with a BET surface area of up to 50 m²/g, examples being quartz, diatomaceous earth, calcium silicate, zirconium silicate, zeolites, metal oxide powders, such as aluminum oxides, titanium oxides, iron oxides, or zinc oxides, or mixed oxides of these, barium sulfate, calcium carbonate, gypsum, silicon nitride, silicon carbide, boron nitride, glass powders, and plastics powders. Examples of reinforcing fillers, i.e. fillers with a BET surface area of at least 50 m²/g, are fumed silica, precipitated silica, carbon black, e.g. furnace black and acetylene black, and silicon-aluminum mixed oxides of large BET surface area.

Examples of fibrous fillers are synthetic fibers and asbestos. The abovementioned fillers can have been hydrophobized, for example through treatment with organosilanes or -siloxanes, or through etherification of hydroxy groups to give alkoxy groups. It is possible to use one type of filler, and it is also possible to use a mixture of at least two fillers.

When the silicone mixtures comprise filler (D), the proportion thereof is preferably from 2 to 60% by weight, in particular from 5 to 50% by weight.

The silicone mixtures can comprise, as constituent (E), a proportion of up to 70% by weight, preferably from 0.0001 to 40% by weight, of further additions. Said additions can by way of example be resinous polyorganosiloxanes, where these differ from the diorganopolysiloxanes (A) and (B), dispersing agents, solvents, adhesion promoters, pigments, dyes, plasticizers, organic polymers, heat stabilizers, etc. Among these are additions such as dyes and pigments, etc. Constituents having thixotropic effect are another constituent (E) that can be present, examples being fine-particle silica and other commercially available additives with thixotropic effect. Siloxanes of the formula HSi(CH₃)₂—[O—Si(CH₃)₂]_{w}—H can also be present as chain extenders, where w is values from 1 to 1000.

Other additions (E) that can also be present serve for controlled adjustment of processing time, onset temperature, and crosslinking rate of the silicone mixture.

These inhibitors and stabilizers are very well known in the field of crosslinking compositions.

It is also possible to add additives which improve the compression set. Hollow bodies can also be added. Blowing agents can also be added in order to produce foams. It is also possible to add polydiorganosiloxanes that are not vinyl-functionalized materials.

The silicone mixture is compounded via mixing, in any desired sequence, of the components listed above.

Preferred embodiments of the process are glob-top applications in the electronics industry, and the production of optical components, e.g. lenses for LEDs; other preferred applications are geometrical shapes which serve for sealing, or as spacers or damping element, examples being O-rings.

The invention also provides silicone moldings obtainable via a process which comprises

1) molding a silicone mixture that can be crosslinked by light,

2) then irradiating the molded silicone mixture with light at from 200 to 500 nm in order to precrosslink the mixture, in such a way that it retains its shape at a temperature T, and

3) then hardening the molded and irradiated silicone mixture thermally at the temperature T to give moldings.

The definitions of all of the above symbols in the above formulae are respectively mutually independent. The silicon atom is tetravalent in all of the formulae.

Unless otherwise stated, all of the quantitative data and percentage data in the examples below is based on weight, all of the pressures are 0.10 MPa (abs.), and all of the temperatures are 20° C.

### EXAMPLES

Silicone mixture A

| | Parts |
|---|---|
| Vinyl polymer 1000 | 90 |
| Fine-particle silica | 3 |
| Glymo | 1 |
| H-siloxane | 6 |
| Platinum catalyst | 0.01 |

Key:
vinyl polymer 1000: ViMe₂SiO—(Me₂SiO)ₛ—SiMe₂Vi where s = 200
glymo: gamma-glycidoxypropyltrimethoxysilane
H-siloxane: Me₃SiO—(MeHSiO)ₜ—(Me₂SiO)ᵤ—SiMe₃ where t + u = 50
fine-particle silica: fumed silica with a BET surface area of 150 m²/g
platinum catalyst: MeCp(PtMe₃)

Properties of materials

| | Value [mPas] |
|---|---|
| Viscosity [D = 0.5/25° C.] | 50 000 |
| Viscosity [D = 0.5/100° C.] | 22 000 |

An electronic component measuring 10×10 mm is completely covered with the abovementioned silicone mixture A. The spread area covered by the silicone is 3.5 cm².

The mixture is then irradiated with light from a UV lamp at 200 mW/cm² for 1 second. After a further 30 seconds, the component with the activated silicone is hardened at 140° C. for 5 min. Under said conditions, the silicone adheres to the circuit board. During the heating process, the shape of the silicone does not change, and the wetted area undergoes no further increase.

If a silicone mixture is formulated comparably, but cannot be activated by light but only by heat, although the area covered after application is likewise 3.5 cm², the process of heating to the target temperature causes the viscosity to decrease, and the area covered by the silicone after the hardening process is therefore markedly greater than 3.5 cm².

1. A process for producing silicone moldings, said method comprising:
molding a silicone mixture to provide a molded silicone mixture, wherein the silicone mixture can be crosslinked by light,
irradiating the molded silicone mixture with light at from 200 to 500 nm in order to precrosslink the mixture, in such a way that the mixture retains its shape at a temperature T, whereby a molded and irradiated silicone mixture is provided, and
hardening the molded and irradiated silicone mixture thermally at the temperature T to provide the silicone moldings,
wherein the process is conducted without using any exterior mold which prescribes a geometric shape.

2. The process as claimed in claim 1, in which the molding step takes place at from 10° C. to 35° C.

3. The process as claimed in claim 1, in which the temperature T is from 100° C. to 180° C.

4. The process as claimed in claim 1, in which the silicone mixture comprises
(A) a polyorganosiloxane which has a viscosity at 25° C. of from 0.1 to 500 000 Pa·s and which comprises at least two alkenyl groups per molecule,
(B) an organosilicon compound comprising at least two SiH functions per molecule, and
(C) a platinum-group catalyst activatable by light at from 200 to 500 nm.

5. The process as claimed in claim 1, the production of optical components and also of geometrical shapes, and glob-top applications in the electronics industry.

6. A silicone molding obtainable via a process comprising:
molding a silicone mixture to provide a molded silicone mixture, wherein the silicone mixture can be crosslinked by light,
irradiating the molded silicone mixture with light at from 200 to 500 nm in order to precrosslink the mixture, in such a way that the mixture retains its shape at a temperature T, whereby a molded and irradiated silicone mixture is provided, and
hardening the molded and irradiated silicone mixture thermally at the temperature T to provide the silicon molding,
wherein the process is conducted without using any exterior mold which prescribes a geometric shape.

7. A silicone molding produced by the process of claim 1.
